(19) United States
(12) Patent Application Publication
(10) Pub. No.: US 2015/0134785 A1
(43) Pub. Date: May 14, 2015

(54) METHOD AND SYSTEM FOR PROVIDING CONTENT SERVICE

(71) Applicant: ELECTRONICS AND TELECOMMUNICATIONS RESEARCH INSTITUTE, Daejeon (KR)

(72) Inventor: Young Hwa KIM, Daejeon (KR)

(21) Appl. No.: 14/527,980

(22) Filed: Oct. 30, 2014

(30) Foreign Application Priority Data
Nov. 8, 2013 (KR) 10-2013-0135821

(51) Int. Cl. H04L 29/08; H04L 12/26; H04L 12/927

(52) U.S. Cl. CPC H04L 67/10; H04L 47/805; H04L 43/08
USPC 709/219

(57) ABSTRACT

A content service providing system includes a content transfer control apparatus that is connected to a centralized control network. The content transfer control apparatus provides content data corresponding to a content request from a user terminal to the user terminal according to a forwarding rule according to topology of the centralized control network.

### CROSS-REFERENCE TO RELATED APPLICATION

This application claims priority to and the benefit of Korean Patent Application No. 10-2013-0135821 filed in the Korean Intellectual Property Office on Nov. 8, 2013, the entire contents of which are incorporated herein by reference.

### BACKGROUND OF THE INVENTION

1. Field of the Invention

The present invention relates to a method and system for providing a content service. More particularly, the present invention relates to a method and system that transfers contents to a user terminal in a centralized control network.

2. Description of the Related Art

In general, a content service is provided with an Internet-based unicast method. Thereby, a service user receives a content stream in which quality of service (QoS) is not guaranteed, and a network has a burden of considerable network overhead due to the content stream that is generated in a large volume.

Nowadays, a change in IT service and technology environment such as network operation management cost, mobility, and virtualization requires a large change in networking technology. Such a trend requires efficient automation of the control and management of a network, particularly in a communication network, and requires integration and control of computing and networking resources. For this purpose, as a virtual network is separated while maintaining hardware performance, a concept of a centralized control network such as a soft structure, i.e., a software defined network (SDN), that can dynamically control an operation of a communication network according to various applications and environments has been gradually embodied.

Because such a centralized control network provides a global topology view of a network and centralizes control of a network level, operation and management of the network can be easily performed and quick development of innovative services can be easily performed, and a mutual operation with other services can be widely performed.

### SUMMARY OF THE INVENTION

The present invention has been made in an effort to provide a method and system for providing a content service having advantages of being capable of reducing overhead of a network using a characteristic of a centralized control network and guaranteeing QoS to a user.

An exemplary embodiment of the present invention provides a method of providing a content service in a content service providing system. The method includes: receiving, by a content transfer control apparatus that is connected to a centralized control network, a content request from a user terminal; and transmitting, by the content transfer control apparatus, content data corresponding to the content request to the user terminal according to a forwarding rule according to a topology of the centralized control network.

The transmitting of content data may include: determining, by the content transfer control apparatus, a traffic engineering parameter based on topology of the centralized control network and quality of service (QoS) that the user terminal requests; and setting, by a central control apparatus of the centralized control network, the forwarding rule for transfer nodes of the centralized control network according to the traffic engineering parameter.

The setting of the forwarding rule may include setting, by the central control apparatus, the forwarding rule with a proactive method.

The transmitting of content data may include converting content data corresponding to a content request according to specification information of the user terminal.

The method may further include downloading, by the content transfer control apparatus, the content data from a content server of a first area that the content transfer control apparatus manages, before the transmitting of content data.

The method may further include: notifying the central control apparatus of the centralized control network of downloading of the content data, after the transmitting of content data; and receiving statistical information of the downloading from the central control apparatus.

The centralized control network may include a software defined network.

Another embodiment of the present invention provides a method of providing a content service in a content service providing system. The method includes: receiving, by a first content transfer control apparatus that is connected to a first centralized control network of a plurality of content transfer control apparatuses, a content request from a user terminal; and transmitting, by a second content transfer control apparatus of the plurality of content transfer control apparatuses, content data corresponding to the content request to the user terminal according to a forwarding rule according to topology of the first centralized control network.

The transmitting of content data may include: determining, by the second content transfer control apparatus, a traffic engineering parameter based on topology of the first centralized control network and quality of service (QoS) that the user terminal requests; and setting, by a central control apparatus of the centralized control network, a forwarding rule for transfer nodes of the first centralized control network according to the traffic engineering parameter.

The setting of the forwarding rule may include setting, by the central control apparatus, the forwarding rule with a proactive method.

The transmitting of content data may further include downloading the content data from the content server, when content data corresponding to the content request exists at a content server that the second content transfer control apparatus manages.

The transmitting of content data may further include converting the content data according to specification information of the user terminal.

The method may further include: notifying a central control apparatus of a second centralized control network to which the second content transfer control apparatus is connected of downloading of the content data through the central control apparatus of the first centralized control network, after the transmitting of content data; and receiving statistical information of the downloading from the central control apparatus of the second centralized control network through the central control apparatus of the first centralized control network.

Yet another embodiment of the present invention provides a system that provides a content service. The system includes a content server and a content transfer control apparatus. The content server manages content. The content transfer control apparatus receives content data corresponding to a content request from a user terminal from the content server, and transfers the content data to the user terminal according to a forwarding rule according to topology of a local centralized control network.

The content transfer control apparatus may convert content data corresponding to the content request according to specification information of the user terminal, and the content request may include specification information of the user terminal.

The content transfer control apparatus may determine a traffic engineering parameter based on topology of the local centralized control network and QoS that the user terminal requests, the content request may include the QoS that the user terminal requests, and the forwarding rule may be set according to the traffic engineering parameter.

### BRIEF DESCRIPTION OF THE DRAWINGS

FIG. 1 is a diagram illustrating an example of a centralized control network according to an exemplary embodiment of the present invention.

FIG. 2 is a diagram illustrating an example of a content service providing system according to an exemplary embodiment of the present invention.

FIG. 3 is a flowchart illustrating an example of a method of providing a content service of a content service providing system according to an exemplary embodiment of the present invention.

FIG. 4 is a diagram illustrating another example of a content service providing system according to an exemplary embodiment of the present invention.

FIG. 5 is a flowchart illustrating another example of a method of providing a content service of a content service providing system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and a system for providing a content service according to an exemplary embodiment of the present invention will be described in detail with reference to the drawings.

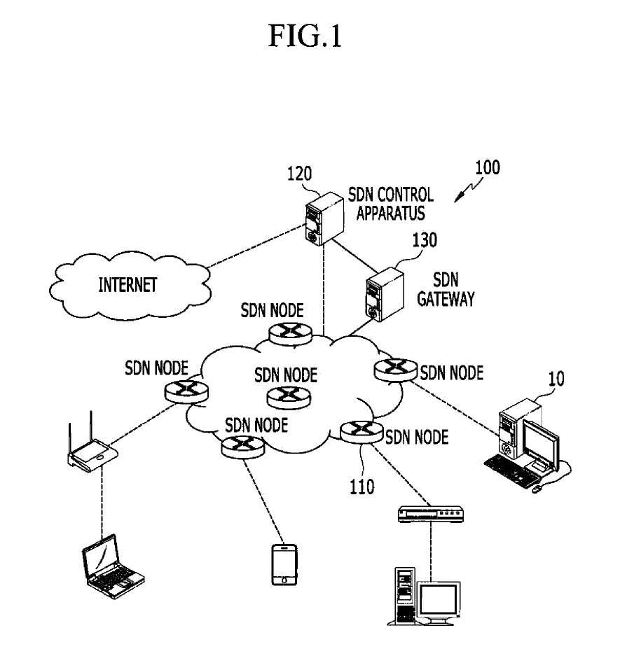

FIG. 1 is a diagram illustrating an example of a centralized control network according to an exemplary embodiment of the present invention.

Referring to FIG. 1, the centralized control network, for example, a software defined, network (SDN) 100, includes a plurality of SDN nodes 110, an SDN control apparatus 120, and an SDN gateway 130.

The plurality of SDN nodes 110 transmit content data to a plurality of user terminals 10, respectively. Each SDN node 110 may include an SDN switch and a router. The plurality of SDN nodes 110 may include a cache server that stores content data.

The SDN control apparatus 120 controls a plurality of SDN nodes 110. The SDN control apparatus 120 may be connected to the Internet.

The SDN gateway 130 distributes content data that is transferred from a content server to a network.

The user terminal 10 is a terminal that a user uses, such as a laptop computer, a smart phone, and a desktop PC.

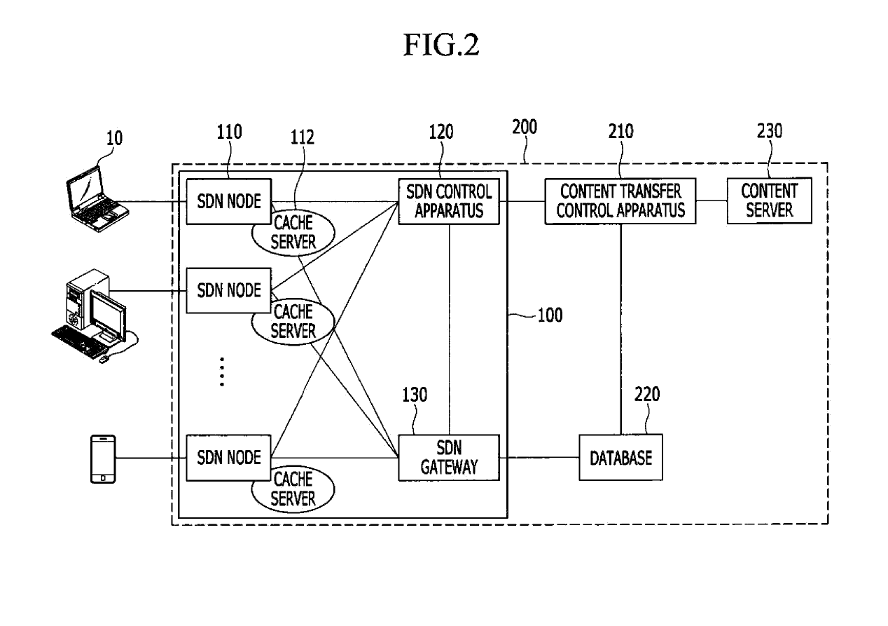

A content service providing system according to an exemplary embodiment of the present invention provides content to the user terminal 10 through such a centralized control network, thereby solving the problem of overhead of a network or a user's QoS problem using a characteristic of the centralized control network. Hereinafter, a system and method for providing a content service according to an exemplary embodiment of the present invention will be described in detail with reference to FIGS. 2 to 5.

FIG. 2 is a diagram illustrating an example of a content service providing system according to an exemplary embodiment of the present invention.

Referring to FIG. 2, a content service providing system 200 includes an SDN 100, a content transfer control apparatus 210, a database 220, and a content server 230. The SDN 100 includes a plurality of SDN nodes 110 each including a cache server 112, an SDN control apparatus 120, and an SON gateway 130, as shown in FIG. 1.

The content transfer control apparatus 210 interfaces with the user terminal 10.

When the user terminal 10 requests content data, the content transfer control apparatus 210 collects content request information, converts original content data that is provided from the content server 230 according to terminal information, and stores the converted content data at the database 220. The content request may include URI, user information, terminal information, a reservation time, and quality of service (QoS). The terminal information may include specification information such as a type and an ability of a user terminal.

The database 220 stores content data that is converted by the content transfer control apparatus 210.

The content server 230 stores and manages original content data and provides corresponding content data according to a content request from the content transfer control apparatus 210.

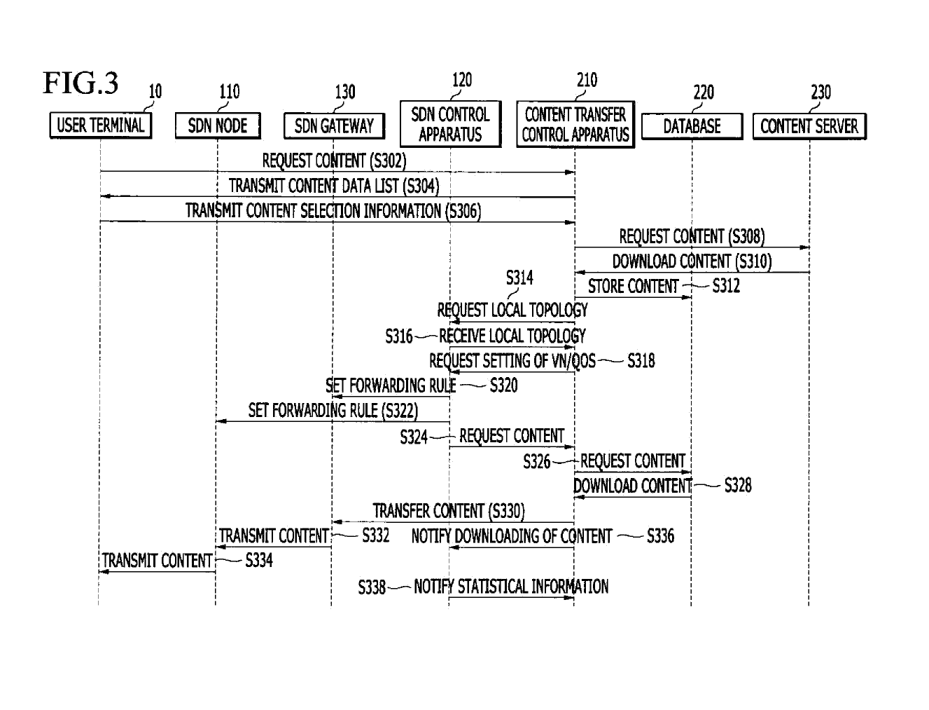

FIG. 3 is a flowchart illustrating an example of a method of providing a content service of a content service providing system according to an exemplary embodiment of the present invention.

Referring to FIG. 3, a user requests content through the user terminal 10 (S302).

When the content transfer control apparatus 210 receives a content request from the user terminal 10, the content transfer control apparatus 210 transmits a content data list of content that can be provided according to the content request to the user terminal 10 (S304).

When a content data list is received through the user terminal 10, the user selects desired content data, and the user terminal 10 transmits the user's content selection information to the content transfer control apparatus 210 (S306).

The content transfer control apparatus 210 requests content corresponding to the user's content selection information from the content server 230 (S308), and downloads the user's desired content data from the content server 230 (S310).

The content transfer control apparatus 210 converts content data that is downloaded from the content server 230 according to specification information of the user terminal 10 and stores the converted content data at the database 220 (S312). In this case, the content transfer control apparatus 210 requests local topology from the SDN control apparatus 120 (S314) and receives the local topology from the SDN control apparatus 120 (S316).

The content transfer control apparatus 210 determines a virtual network VN and a traffic engineering parameter based on the local topology and QoS that the user requests, and requests setting of the virtual network VN and the traffic engineering parameter Qos to the SDN control apparatus 120 (S318).

The SDN control apparatus 120 sets a forwarding rule with a proactive method for an SON gateway and an SDN node in a virtual network VN range according to a setting request of the virtual network VN and the traffic engineering parameter QoS (S320 and S322). In the proactive method, all SDN nodes always maintain a newest forwarding rule with a method that updates a forwarding rule between an SDN gateway and an SDN node periodically or whenever a change occurs in a network topology for the SDN control apparatus 120.

Thereafter, the SDN control apparatus 120 requests content from the content transfer control apparatus 210 while transmitting a setting response of a virtual network VN and a traffic engineering parameter QoS to the content transfer control apparatus 210 (S324).

The content transfer control apparatus 210 requests content data from the database 220 according to a content request condition that a service user wants (S326) and downloads the content data from the database 220 (S328).

The content transfer control apparatus 210 transfers the downloaded content data to the SDN gateway 130 (S330).

The SDN gateway 130 transmits content data to a specific SDN node 110 according to a preset forwarding rule (S332), and the specific SDN node 110 transmits content data to the user terminal 10 (S334).

The content transfer control apparatus 210 notifies the SDN control apparatus 120 of downloading of contents (S336), and the SDN control apparatus 120 notifies the content transfer control apparatus 210 of statistical information about downloading of content data (S338). The statistical information is various collected information (e.g., table, flow, port, and queue) about corresponding content in a data plane of an SDN network that is formed with the SON node 110 and the SDN gateway 130. That is, the statistical information may include a transmitting packet quantity, a receiving packet quantity, and a discarding packet quantity, and the content transfer control apparatus 210 may determine whether a desired QoS request is appropriately executed in an SDN network based on the statistical information.

In this way, because the content service providing system 200 according to an exemplary embodiment of the present invention can provide content data to the user terminal 10 according to a forwarding rule according to QoS of the user terminal 10, which is a characteristic of a centralized control network, the content service providing system 200 can provide a content service in which QoS is guaranteed, and overhead of the network can be reduced.

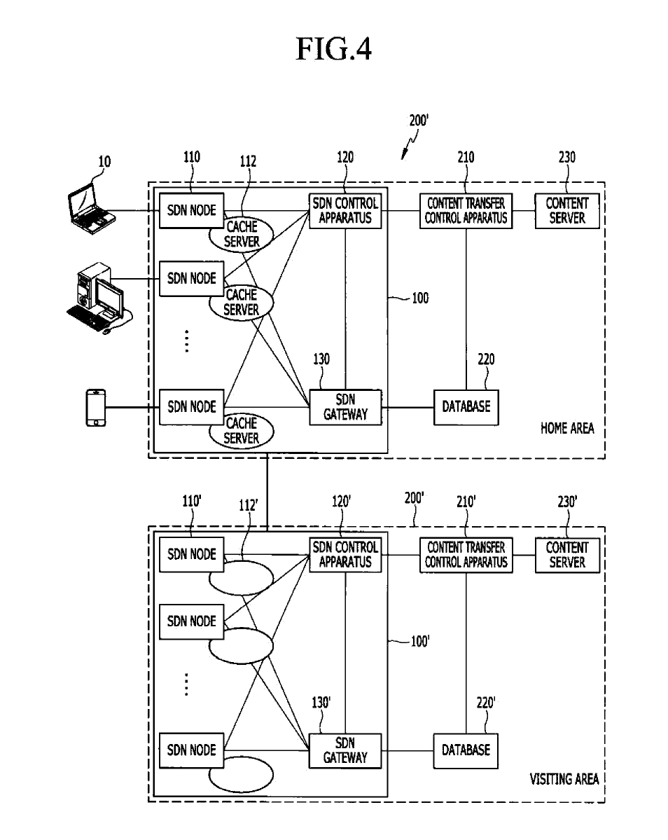

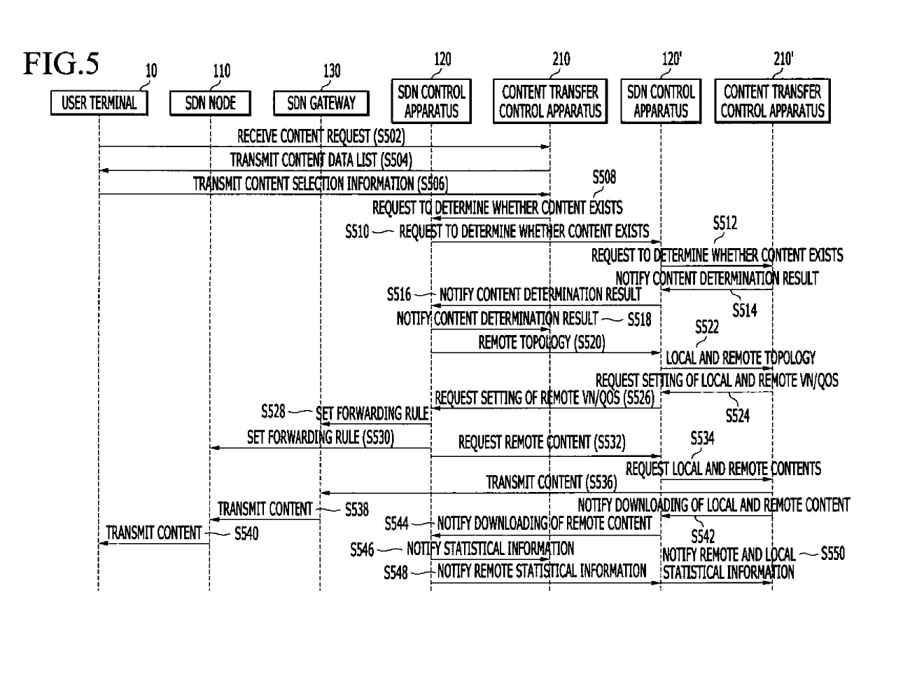

Content data that the user wants may not exist at the content server 230 interlocking with the SDN 100. A method in which the content transfer control apparatus 210 provides content data in such a case will be described with reference to FIGS. 4 and 5.

FIG. 4 is a diagram illustrating another example of a content service providing system according to an exemplary embodiment of the present invention.

Referring to FIG. 4, an area that the content transfer control apparatus 210 interlocking with the SDN 100 manages is referred to as a home area, and an area that another content transfer control apparatus 210′ manages is referred to as a visiting area.

The visiting area includes an SDN 100′, the content transfer control apparatus 210′, a database 220′, and a content server 230′ like a home area. In this case, an SDN node 110′, an SDN control apparatus 120′, and an SDN gateway 130′ of the SDN 100′ perform the same functions as the SDN node 110, the SON control, apparatus 120, and the SON gateway 130 of the SDN 100.

That is, the content service providing system 200′ includes SDNs 100 and 100′, content transfer control apparatuses 210 and 210′, databases 220 and 220′, and content servers 230 and 230′ corresponding to each area.

When the user's desired content data does not exist at the content server 230 of a home area at which the user terminal 10 is located, the content service providing system 200′ determines whether the user's desired content data exists at the content server 230′ of a visiting area, and may provide the user's desired content data from the content server 230′ of the visiting area to the user terminal 10.

FIG. 5 is, a flowchart illustrating another example of a method of providing a content service of a content service providing system according to an exemplary embodiment of the present invention.

Referring to FIG. 5, when the content transfer control apparatus 210 receives a content request from the user terminal 10 (S502), the content transfer control apparatus 210 transmits a content data list of content that can be provided to the user terminal 10 according to the content request (S504).

When the content data list is received through the user terminal 10, the user selects desired content data, and the user terminal 10 transmits the user's content selection information to the content transfer control apparatus 210 (S506).

The content transfer control apparatus 210 requests content corresponding to the user's content selection information from the content server 230. In this case, when content corresponding to the user's content selection information does not exist in the content server 230, the content transfer control apparatus 210 requests to determine whether the content exists in the visiting area from the SDN control apparatus 120 (S508).

The SDN control apparatus 120 requests to determine whether content corresponding to the user's content selection information exists from the SDN control apparatus 120′ of the visiting area (S510), and the SDN control apparatus 120′ requests to determine whether the content exists from the content transfer control apparatus 210′ (S512).

When the content transfer control apparatus 210′ receives the request for content determination from the SDN control apparatus 120′, the content transfer control apparatus 210′ determines whether the content corresponding to the user's content selection information exists at the content server 230′, and notifies the SDN control apparatus 120′ of a content determination result (S514).

Thereafter, the SDN control apparatus 120′ notifies the SDN control apparatus 120 of the content determination result (S516), and the SDN control apparatus 120 notifies the content transfer control apparatus 210 of the content determination result (S518).

If the content corresponding to the user's content selection information is found to exist at the content server 230′ of the visiting area through the content determination result, the SDN control apparatus 120 transmits topology, i.e., remote topology, of the SDN control apparatus 120 to the SDN control apparatus 120′ (S520).

The SDN control apparatus 120′ transmits the topology, i.e., the local topology, of the SDN control apparatus 120′ and remote topology information that is received from the SDN control apparatus 120 to the content transfer control apparatus 210′ (S522). Here, for convenience of description, the topology of the SDN control apparatus 120′ of a visiting area based on a visiting area in which the user's desired content data exists is referred to as local topology, and topology of the SDN control apparatus 120 of the home area in which the user's desired content data does not exist is referred to as remote topology. Further, hereinafter, for convenience of description, the term “local” is used for a virtual network VN and a traffic engineering parameter QoS of a visiting area, and the term “remote” is used for a virtual network UN and a traffic engineering parameter QoS of a home area.

The content transfer control apparatus 210′ determines a virtual network

VN and a traffic engineering parameter QoS based on the local topology, the remote topology, and the QoS that a user requests, and requests setting of local and remote virtual networks VN and a traffic engineering parameter QoS to the SDN control apparatus 120′ (S524).

The SDN control apparatus 120′ transfers the setting request of the remote virtual network VN and the traffic engineering parameter QoS from the content transfer control apparatus 210′ to the SDN control apparatus 120 (S526).

The SDN control apparatus 120 sets a forwarding rule with a proactive method for an SDN gateway and an SDN node in a virtual network VN range according to the setting request of the remote virtual network VN and the traffic engineering parameter QoS (S528 and S530).

Thereafter, the SON control apparatus 120 requests the remote content while transmitting the setting response of the remote virtual network VN and the traffic engineering parameter QoS to the SDN control apparatus 120′ (S532).

Thereafter, the SDN control apparatus 120′ requests local and remote contents from the content transfer control apparatus 210′ (S534).

When content corresponding to the user's content selection information exists at the content server 230′, the content transfer control apparatus 210′ downloads the user's desired content data from the content server 230′, converts content data that is downloaded from the content server 230′ according to specification information of the user terminal 10, and stores the converted content data at the database 220′.

The content transfer control apparatus 210′ downloads the content data corresponding to the user's content selection information from the database 220′.

The content transfer control apparatus 210′ transmits the downloaded content data to the SON gateway 130 (S536).

The SDN gateway 130 transmits content data to a specific SON node 110 according to a preset forwarding rule (S538), and the specific SDN node 110 transmits the content data to the user terminal 10 (S540).

The content transfer control apparatus 210′ notifies the SDN control apparatus 120′ of downloading of local and remote contents (S542), and the SDN control apparatus 120′ notifies the SDN control apparatus 120 of downloading of the remote content (S544).

The SDN control apparatus 120 notifies the content transfer control apparatus 210 and the SDN control apparatus 120′ of remote statistical information about downloading of remote content data (S546 and S548), and the SDN control apparatus 120′ notifies the content transfer control apparatus 210′ of remote and local statistical information (S550). Such statistical information may be periodically or non-periodically notified.

According to an exemplary embodiment of the present invention, overhead of a network can be reduced using a characteristic of a centralized control network, and contents in which QoS is guaranteed can be provided to a user. Therefore, as a network service provider can generate a value of a content service itself and can be interlocked with other services that are supported in a centralized control network such as an SDN, an additional value can be easily generated.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of providing a content service in a content service providing system, the method comprising:
receiving, by a content transfer control apparatus that is connected to a centralized control network, a content request from a user terminal; and
transmitting, by the content transfer control apparatus, content data corresponding to the content request to the user terminal according to a forwarding rule according to topology of the centralized control network.

2. The method of claim 1, wherein the transmitting of content data comprises:
determining, by the content transfer control apparatus, a traffic engineering parameter based on topology of the centralized control network and quality of service (QoS) that the user terminal requests; and
setting, by a central control apparatus of the centralized control network, the forwarding rule for transfer nodes of the centralized control network according to the traffic engineering parameter.

3. The method of claim 2, wherein the setting of the forwarding rule comprises setting, by the central control apparatus, the forwarding rule with a proactive method.

4. The method of claim 1, wherein the transmitting of content data comprises converting content data corresponding to a content request according to specification information of the user terminal.

5. The method of claim 1, further comprising downloading, by the content transfer control apparatus, the content data from a content server of a first area that the content transfer control apparatus manages, before the transmitting of content data.

6. The method of claim 5, further comprising:
notifying the central control apparatus of the centralized control network of downloading of the content data, after the transmitting of content data; and
receiving statistical information of the downloading from the central control apparatus.

7. The method of claim 1, wherein the centralized control network comprises a software defined network (SDN).

8. A method of providing a content service in a content service providing system, the method comprising:
receiving, by a first content transfer control apparatus that is connected to a first centralized control network of a plurality of content transfer control apparatuses, a content request from a user terminal; and
transmitting, by a second content transfer control apparatus of the plurality of content transfer control apparatuses, content data corresponding to the content request to the user terminal according to a forwarding rule according to topology of the first centralized control network.

9. The method of claim 8, wherein the transmitting of content data comprises:
determining, by the second content transfer control apparatus, a traffic engineering parameter based on topology of the first centralized control network and quality of service (QoS) that the user terminal requests; and
setting, by a central control apparatus of the first centralized control network, a forwarding rule for transfer nodes of the first centralized control network according to the traffic engineering parameter.

10. The method of claim 9, wherein the setting of the forwarding rule comprises setting, by the central control apparatus, the forwarding rule with a proactive method.

11. The method of claim 9, wherein the transmitting of content data further comprises downloading the content data from the content server, when content data corresponding to the content request exists at a content server that the second content transfer control apparatus manages.

12. The method of claim 11, wherein the transmitting of content data further comprises converting the content data according to specification information of the user terminal.

13. The method of claim 11, wherein the first content transfer control apparatus is the same as the second content transfer control apparatus.

14. The method of claim 9, further comprising:
notifying a central control apparatus of a second centralized control network to which the second content transfer control apparatus is connected of downloading of the content data through the central control apparatus of the first centralized control network, after the transmitting of content data; and
receiving statistical information of the downloading from the central control apparatus of the second centralized control network through the central control apparatus of the first centralized control network.

15. A system that provides a content service, the system comprising:
a content server that manages content; and
a content transfer control apparatus that receives content data corresponding to a content request from a user terminal from a content server, and that transfers the content data to the user terminal according to a forwarding rule according to topology of a local centralized control network.

16. The system of claim 15, wherein the content transfer control apparatus converts content data corresponding to the content request according to specification information of the user terminal, and
the content request comprises specification information of the user terminal.

17. The system of claim 15, wherein the content transfer control apparatus determines a traffic engineering parameter based on topology of the local centralized control network and QoS that the user terminal requests,
the content request comprises QoS that the user terminal requests, and
the forwarding rule is set according to the traffic engineering parameter.

18. The system of claim 15, wherein the content transfer control apparatus receives the content request from the user terminal.

19. The system of claim 15, wherein the content transfer control apparatus is connected to a remote centralized control network, and receives the content request through the local centralized control network.

20. The system of claim 15, wherein the centralized control network comprises a software defined network (SDN).
